(19) United States
(12) Patent Application Publication
(10) Pub. No.: US 2016/0108702 A1
(43) Pub. Date: Apr. 21, 2016

(54) METHOD AND DEVICE FOR RECOVERING OIL

(71) Applicant: Yukinobu Mori, (US)

(72) Inventor: Yukinobu MORI, London (GB)

(21) Appl. No.: 14/517,617

(22) Filed: Oct. 17, 2014

(51) Int. Cl. E21B 36/00; C09K 8/592; E21B 43/243

(52) U.S. Cl. CPC E21B 36/008; E21B 43/243; C09K 8/592

(57) ABSTRACT

There is provided a method or a device for recovering oil economically and with little impact on the environment. With the present invention's method and device for recovering oil, a heat-generating means is installed inside one of at least two pipes that are parallelly inserted into the soil (for example, an oil sand stratum or a core stratum). The heat is exerted on the oil contained in the soil so as to reduce the viscosity of oil, which is then recovered via the other pipe. The heat-generating means reacts amphoteric metal or its alloy with an alkaline aqueous solution in the pipe and then combusts the hydrogen generated by the reaction.

The present invention relates to a method and device for recovering high-viscosity oil.

### BACKGROUND ART OF THE INVENTION

Oil sand (i.e., sand containing oil) has recently been attracting attention as a type of a petroleum resource. The oil contained in an oil sand stratum has a boiling point of over 100° C., and it is not easy to recover oil that is at its low temperature, because under that condition the oil's viscosity is too high. Therefore, conventionally, in recovering oil from an oil sand stratum, steam is pressed into and brought into contact with the oil sand stratum, and the viscosity of the oil is reduced by the heat of the steam. Thereafter, the oil is introduced into a recovery pipe by gravity and is then pumped up to the surface of the ground (see Patent Document 1, for example). In Patent Document 1, prior to discharging the oil by steam, separation of the oil and the sand is promoted by pressing a surfactant into the oil sand stratum, so that recovery efficiency is improved.

However, in a method for recovering oil by using steam, steam is generated by combusting natural gas, which leads to the environmental problem that carbon dioxide gas is generated. Furthermore, recently rock stratums containing oil (hereinafter referred to as “core stratum(s)”) have been discovered below oil sand stratums. However, typically such a core stratum is significantly deep, which is a problem because the heat of the steam cannot reach the core stratum.

[Patent Document 1] Japanese Unexamined Patent Application No. 2002-338968

### DISCLOSURE OF THE INVENTION

### Problems to be Solved by the Invention

A conventional method using steam when recovering oil, especially for heavy crudes, requires combustion of natural gas and the like to produce steam from water. Therefore, a large amount of such energy is consumed, and carbon dioxide is generated by the combustion of the energy source, which causes environmental problems such as global warming. Also, in addition to consuming much energy, this method requires a facility for generating a large amount of steam, which makes recovering oil very costly.

The present invention has been made in light of the above-mentioned problems, and one objective of the present invention is to provide a method and a device for recovering oil—for example, oil existing in an oil sand stratum or a core stratum—without using steam.

### Means for Solving the Problems

The method for recovering oil described in claim 1 is characterized such that after amphoteric metal or its alloy is filled inside at least one of two pipes that are parallelly inserted into an oil sand stratum, an alkaline aqueous solution is supplied to react with the amphoteric metal or its alloy, and both the heat and the heated hydrogen gas that are generated by said reaction are exerted on the oil sand stratum so as to separate the oil from the oil sand stratum, which oil is then collected and subsequently recovered via the other pipe.

The method for recovering oil described in claim 2 is characterized such that after amphoteric metal or its alloy is inserted inside at least one of two pipes that are parallelly inserted into an oil sand stratum in the soil, an alkaline aqueous solution is supplied to react with the amphoteric metal or its alloy, and the hydrogen generated by this reaction is combusted, and the heat generated by said combustion is exerted on the oil sand stratum so as to separate the oil from the oil sand stratum, which oil is then collected and subsequently recovered via the other pipe.

The method described in claim 3 is characterized such that there is exerted on the oil sand stratum—in addition to the heat from the combustion of the hydrogen—the heat generated by the reaction of the alkaline aqueous solution with the amphoteric metal or its alloy.

The method for recovering oil described in claim 4 is characterized such that amphoteric metal used is one or more selected from among aluminum (Al), zinc (Zn), tin (Sn), and lead (Pb).

The method described in claim 5 is characterized such that an alkaline aqueous solution used contains one or more selected from among sodium hydroxide (NaOH), potassium hydroxide (KOH), and calcium hydroxide (Ca(OH)₂).

The method described in claim 6 is characterized such that hydroxide of the amphoteric metal is separated and recovered from a reaction product generated by the reaction of the amphoteric metal or its alloy with the alkaline aqueous solution.

The method described in claim 7 is characterized such that both hydroxide of the amphoteric metal and any unused alkaline aqueous solution are simultaneously separated from said reaction product so as to enable reuse of the alkaline aqueous solution.

The device described in claim 8 for recovering oil, is characterized such that it (1) consists of (a) at least two pipes that are inserted into the soil, one of which pipes is filled with amphoteric metal or its alloy, (b) an alkali tank that stores an alkaline aqueous solution, and with the other pipe supplying the alkaline aqueous solution from said alkali tank to the first-mentioned pipe, (2) applies to said oil the heat from the combustion of hydrogen and the heat from the reaction of the amphoteric metal or its alloy with the alkaline aqueous solution, and (3) collects and recovers the resultant flown oil.

The device described in claim 9 for recovering oil is characterized such that it (1) consists of (a) at least two pipes that are inserted into the soil, (b) amphoteric metal or its alloy that is filled inside one of the pipes, (c) an alkali tank that stores an alkaline aqueous solution, (d) a combustion means that supplies the alkaline aqueous solution from said alkali tank to the aforementioned pipe and combusts hydrogen generated by reacting the alkaline aqueous solution with said amphoteric metal or its alloy, and with the other pipe applying and exerting on said oil the combustion heat generated by said combustion of hydrogen, and then collecting and recovering the flown oil that is produced due to the heat generated by said combustion of hydrogen.

The device described in claim 10 for recovering oil is characterized such that said two pipes are provided in an oil sand stratum or a core stratum below said oil sand stratum.

The device described in claim 11 for recovering oil is characterized such that amphoteric metal used is one or more selected from among aluminum (Al), zinc (Zn), tin (Sn), and lead (Pb).

The device described in claim 11 for recovering oil is characterized such that an alkaline aqueous solution used contains one or more selected from among sodium hydroxide (NaOH), potassium hydroxide (KOH), and calcium hydroxide (Ca(OH)₂).

The device described in claim 13 is characterized such that it includes a recovery tank that (1) is provided to recover and precipitate a reaction product generated by the reaction of the alkaline aqueous solution and amphoteric metal or its alloy, and (2) is connected with said alkali tank so as to circulate the alkaline aqueous solution, which is a supernatant, in said recovery tank.

### Effects of the Invention

In the present invention's method for recovering oil, reaction heat generated by a reaction of amphoteric metal or its alloy and an alkaline aqueous solution, heated hydrogen gas, or heat resulting from the combustion of hydrogen can be exerted on an oil sand stratum or a core stratum (existing below the oil sand stratum), and therefore the oil can be separated and recovered from the oil sand stratum or the core stratum. The oil is separated not by using steam but by using the heat generated by the reaction of the amphoteric metal or its alloy and the alkaline aqueous solution, by using heated hydrogen gas, or by using the heat resulting from the combustion of hydrogen. Therefore, there is no need to combust petroleum or the like in order to produce the steam. As a result, the generation of carbon dioxide can be avoided, which benefits the environment, and manufacturing costs can be reduced.

When steam is used, high-temperature steam must be used, but it cools and is useless until it reaches the oil sand stratum or the core stratum, which causes trouble. However, when the hydrogen is generated inside a pipe and combusted near the oil sand stratum or the core stratum, the heat from said combustion can be surely exerted on the oil without loss of energy.

The cost of recovering oil can be reduced when hydroxide of amphoteric metal, which is useful as a raw material for industrial products, is separated and recovered from a reaction product that is generated by the reaction of the amphoteric metal or its alloy and an alkaline aqueous solution. Also, by separating the unused alkaline aqueous solution from the reaction product and reusing that alkaline aqueous solution, not only can hydroxide of the amphoteric metal be recovered from the reaction product, the amount of alkaline aqueous solution necessary to be obtained to react with the amphoteric metal or its alloy can be reduced.

The present invention's device for recovering oil can (1) exert on an oil sand stratum or a core stratum (existing below the oil sand stratum) (a) heat that is generated by a reaction of amphoteric metal or its alloy with an alkaline aqueous solution, (b) heated hydrogen gas, or (c) heat resulting from combusting hydrogen, (2) fluidize the oil, (3) separate the oil from the oil sand stratum or the core stratum, and (4) recover the oil.

Amphoteric metal used in the present invention is one or more selected from among aluminum (Al), zinc (Zn), tin (Sn), and lead (Pb), any of which is abundant around us and easily obtainable.

An alkaline aqueous solution used in the present invention contains one or more selected from among sodium hydroxide (NaOH), potassium hydroxide (KOH), and calcium hydroxide (Ca(OH)₂), any of which is abundant around us and easily obtainable.

The present invention's device also includes a recovery tank that is provided to recover and precipitate the reaction product generated by the reaction of the alkaline aqueous solution and amphoteric metal or its alloy. The recovery tank is connected with an alkali tank so as to recirculate the unused alkaline aqueous solution, which is a supernatant, from the recovery tank, and therefore the amount of alkaline aqueous solution necessary to be obtained to react with the amphoteric metal or its alloy can be reduced.

### BEST MODES FOR CARRYING OUT THE INVENTION

With this invention, in order to recover oil, heat is applied so as to reduce the oil's viscosity so that it can be recovered. FIG. 1 shows the first embodiment of the present invention.

As shown in FIG. 1, a reaction pipe 3 and a recovery pipe 4 are parallelly inserted into an oil sand stratum 2 in soil 1. The reaction pipe 3 is a pipe in which reactions take place, and the recovery pipe 4 is a pipe for recovering oil 5 after the oil 5 is separated from the oil sand stratum 2.

The recovery pipe 4 is positioned lower than the reaction pipe 3. When oil that has been separated from the oil sand stratum 2 reaches the recovery pipe 4 due to gravity, the oil is introduced into the recovery pipe 4. The reaction pipe 3 is used for filtrating into the oil stratum 2 hydrogen gas and reaction heat generated by a chemical reaction. For this reason, the reaction pipe 3 and the recovery pipe 4 must have structures such that gas or liquid can filtrate through them, and, therefore, porous pipes or net-like pipes are used as those pipes.

The reaction pipe 3 and the recovery pipe 4 can be inserted into an oil sand stratum 2 by boring a pit 6 in the soil 1, and press-fitting a plurality of pipes and related items into the oil sand stratum 2 via the pit 6 while the pipes and related items are connected with each other. The reaction pipe 3 and the recovery pipe 4 are connected with the surface of the ground via connection pipes 7 and 8, respectively.

The inside of the reaction pipe 3 is filled with amphoteric metal or its alloy 9. Amphoteric metal or its alloy waste materials such as aluminum cans and lead pipes and amphoteric metal or its alloy pieces discharged when amphoteric metal or its alloy products are manufactured can be used for the amphoteric metal or its alloy 9. These amphoteric metal or its alloy waste materials are smashed into small pieces of amphoteric metal or its alloy 9 that are then inserted into the reaction pipe 3 until the reaction pipe 3 is filled with amphoteric metal or its alloy 9. This use of amphoteric metal or its alloy waste materials reduces the costs of the raw materials, so that the cost of recovering oil can be reduced. Also, the amphoteric metal or its alloy 9 is not limited to the above-mentioned amphoteric metal or its alloy waste materials and can be, for example, an ingot that is formed into a suitable size.

After the reaction pipe 3 has been filled with amphoteric metal or its alloy 9, an alkaline aqueous solution 10 is supplied inside the reaction pipe 3. The alkaline aqueous solution 10 is a hydroxide of an alkaline metal or an alkaline earth metal that reacts with amphoteric metal or its alloy, and can be, for example, a sodium-hydroxide aqueous solution, a potassium-hydroxide aqueous solution, or a calcium-hydroxide aqueous solution. The alkaline aqueous solution 10 is supplied into the reaction pipe 3 through the connection pipe 7 by a pump (not shown) above ground. The supplied alkaline aqueous solution 10 reacts with the amphoteric metal or its alloy 9.

Formula 1 below is the reaction formula when tin is used as the amphoteric metal and a sodium-hydroxide aqueous solution is used as the alkaline aqueous solution. Formula 2 below is the reaction formula when zinc is used as the amphoteric metal and a potassium-hydroxide aqueous solution is used as the alkaline aqueous solution. Formula 3 below is the reaction formula when lead is used as the amphoteric metal and a calcium-hydroxide aqueous solution is used as the alkaline aqueous solution. Formula 4 below is the reaction formula when aluminum is used as the amphoteric metal and a sodium-hydroxide aqueous solution is used as the alkaline aqueous solution.

Sn+2NaOH+4H₂O→Na₂(Sn(OH)₆)+2H₂ [1]

Zn+2KOH+2H₂O→K₂(Zn(OH)₄)+H₂ [2]

Pb+Ca(OH)₂+4H₂O→Ca(Pb(OH)₆)+2H₂ [3]

Al+NaOH+3H₂O→Na(Al(OH)₄)+3/2H₂ [4]

As shown by Formulas 1 to 4, hydrogen is produced by the reaction between the amphoteric metal or its alloy 9 and the alkaline aqueous solution 10. Also, a standard free-energy change in this reaction shown in Formula 4 is −437.8 Kj/mol, and the reaction proceeds quickly. Furthermore, a standard enthalpy change is −415.5 Kj/mol, as a result of which a large amount of reaction heat is generated.

In the embodiment of the present invention, after the amphoteric metal or its alloy 9 and the alkaline aqueous solution 10 were mixed together, the reaction heat reached 100° C. in about 8 minutes, and the generated hydrogen gas reached 80° C.-90° C.

As shown by the arrows E in FIG. 1, the reaction heat and the high-temperature hydrogen gas go out of the reaction pipe 3, come into contact with the oil sand stratum 2 around the reaction pipe 3, and act so as to heat the oil sand stratum 2 so that the oil contained in the oil sand stratum 2 melts and separates from the oil sand stratum 2.

The separated oil flows downward due to gravity. The recovery pipe 4 is arranged below the reaction pipe 3, and the oil flows downward from the oil sand stratum 2 surrounding the reaction pipe 3 and is introduced into the recovery pipe 4 (see reference number 5 in FIG. 1). The recovery pipe 4 is connected with a recovery pump (not shown) on the surface of the ground via the connection pipe 8 and, as shown by the arrow F in FIG. 1, the oil 5 in the recovery pipe 4 is sucked up to the surface of the ground from the recovery pipe 4 and is recovered.

Formula 5 is a formula showing the reaction between the alkaline aqueous solution and the amphoteric metal or its alloy pieces 9 when zinc is used as the amphoteric metal and a calcium-hydroxide aqueous solution is used as the alkaline aqueous solution. This reaction, too, generates heat and high-temperature hydrogen gas. Accordingly, the aqueous solution can be used as a reaction liquid when the oil 5 is separated and recovered from the oil sand stratum 2.

Zn+Ca(OH)₂+2H₂O→Ca(Zn(OH)₄)₂+H₂ [5]

In this embodiment, as described above, the reaction heat and the heated hydrogen gas that are generated by the reaction between the amphoteric metal or its alloy pieces 9 and the alkaline aqueous solution 10 in the reaction pipe 3 act on the oil sand stratum 2 so that the oil 5 can be separated and recovered from the oil sand stratum 2. Therefore, the oil can be separated and recovered without using steam, and thus there is no need for combustion of an energy source to produce steam. Therefore, carbon dioxide gas is not generated, with the result that environmental problems relating to the release of carbon dioxide gas can be avoided and, at the same time, manufacturing costs can be reduced.

FIG. 2 shows a second embodiment of the present invention in which the reaction pipe 3 is inserted in an approximately horizontal direction. Although not shown in FIG. 3, the recovery pipe 4 for recovering the oil is inserted into the oil sand stratum 2 parallel to the reaction pipe 3. In this embodiment, the reaction pipe 3 has a double-pipe structure such that it consists of an inner pipe 3a within an outer pipe 3b. Also, porous pipe material through which gas and liquid can be filtrated is used for both the inner pipe 3a and the outer pipe 3b.

The inner pipe 3a is filled with amphoteric metal or its alloy 9 made of smashed amphoteric metal or its alloy-waste materials. After the inner pipe 3a is filled with the amphoteric metal or its alloy 9, an alkaline aqueous solution 10 is supplied. As a result, a reaction similar to that in the first embodiment occurs in the inner pipe 3a, so that hydrogen gas is produced. The hydrogen gas that is produced is discharged from the inner pipe 3a and introduced into the outer pipe 3b, as shown by the arrows G.

Oxygen gas, or gas containing oxygen (for example, air), is supplied to the outer pipe 3b, as shown by the horizontal broken-line arrows 13. Combustion means 15 are installed along the outside of the inner pipe 3a, which is filled with amphoteric metal or its alloy 9. A heating element such as a nichrome wire or an ignition element such as a burner can be used as the combustion means 15.

In this structure, the hydrogen gas that is discharged from the inner pipe 3a and introduced into the outer pipe 3b is mixed with the oxygen gas 13 in the outer pipe 3b. At that time, the combustion means 15 is actuated to cause the hydrogen gas and oxygen gas to react with each other, and the hydrogen is combusted. A combustion temperature that is about 1.7 times the temperature generated when gasoline is combusted can be obtained. That combustion heat is brought into contact with and exerted on the oil sand stratum 2 around the outer pipe 3b, with the result that the temperature of the oil sand stratum 2 can be raised in a short time, which in turn enables the oil contained in the oil sand stratum 2 to be separated from the stratum in a short time, after which the oil is recovered to the surface of the ground via the recovery pipe.

In this embodiment, hydrogen gas, which is produced by the reaction between the amphoteric metal or its alloy pieces 9 and the alkaline aqueous solution 10 in the inner pipe 3a, is combusted in the outer pipe 3b, and the heat generated by this combustion is exerted on the oil sand stratum 2, so that the oil is separated from the oil sand stratum 2 and recovered without using steam. There is no need for combustion of an energy source and, as a result, both environmental problems and manufacturing costs can be reduced.

With the second embodiment of the present invention, the oil sand stratum 2 is acted on by both the heat generated by the reaction between the alkaline aqueous solution 10 with the amphoteric metal or its alloy pieces 9 and the heat that results from the combustion of hydrogen gas. As a result, the oil in the oil sand stratum 2 can flow quickly, so that oil can be separated from the oil sand stratum 2 more efficiently.

FIG. 3 shows a flow chart of the process in the third embodiment of the present invention. By applying this flow chart, a facility that recovers oil from the oil sand stratum 2 can be constituted. In FIG. 3, a preprocessing tank 21, a smasher 22, and a feeder 23 are sequentially arranged, and the reaction pipe 3 is inserted into the oil sand stratum 2 and downstream of the feeder 23. FIG. 4 also shows a recovery tank 24, a separation tank 25, a crystallizing tank 26, and an alkali tank 27 that stores the alkaline aqueous solution.

In the preprocessing tank 21, stains, printing ink and the like are removed from the amphoteric metal or its alloy waste materials 31 such as aluminum cans and electrodes of a used lead acid battery, and then the waste materials are washed. Thereafter, the amphoteric metal or its alloy waste materials 31 are supplied into the smasher 22, wherein they are smashed and formed into small pieces of amphoteric metal or its alloy 9, so that the surface area of each piece is increased. The amphoteric metal or its alloy 9 is loaded into a hopper 23a of the feeder 23, and is then inserted into the reaction pipe 3 by the feeder 23. After the reaction pipe 3 is filled with amphoteric metal or its alloy 9, an alkaline aqueous solution 10 is supplied into the reaction pipe 3, and the above-mentioned reaction takes place in the reaction pipe 3.

Salts of hydroxide of amphoteric metal, such as sodium hexahydroxostannate (Na₂(Sn(OH)₆)), potassium tetrahydroxozincate (K2(Zn(OH)₆)), calcium hexahydroxoplumbate (Ca₂(Pb(OH)₄)), tetrahydroxoaluminate (Na(Al(OH)₄)) and calcium tetrahydroxozincate (Ca(Zn(OH)₄)) as in Formulas 1 to 5, are produced by the reaction between the amphoteric metal or its alloy 9 and the alkaline aqueous solution 10. The reaction between the amphoteric metal or its alloy 9 and the alkaline aqueous solution 10 generates both high-temperature reaction heat and high-temperature hydrogen gas, both of which are then exerted on the oil sand stratum 2 from the reaction pipe 3, so that oil can be separated from the oil sand stratum 2 and then recovered. Also, the hydrogen gas generated by the reaction is mixed with oxygen and combusted, and the generated combustion gas also is exerted on the oil sand stratum 2, further promoting separation and recovery of oil from the oil sand stratum 2 from the recovery pipe 4.

In this embodiment, after oil is separated and recovered, the reaction product produced by the reaction between the amphoteric metal or its alloy 9 and the alkaline aqueous solution 10, as well as the unused alkaline aqueous solution 10 left over after the reaction, are recovered in the recovery tank 24, in which the reaction product is precipitated and the alkaline aqueous solution 10 becomes a supernatant. The recovery tank 24 is connected with the alkali tank 27 by a pump 28, and the alkaline aqueous solution 10, which is the supernatant, is returned to the alkali tank 27 for reuse by being supplied into the reaction pipe 3 by the action of the pump 28. Accordingly, consumption of the alkaline aqueous solution is reduced, which in turn reduces the oil-recovery cost.

The reaction product that is precipitated in the recovery tank 24 is transferred to the separation tank 25, where pH is adjusted and then salts of hydroxide of the amphoteric metal are separated. The reaction product is then transferred to the crystallizing tank 26, in which hydroxide of the amphoteric metal is separated from the reaction product by precipitation, and the hydroxide of the amphoteric metal that has been separated out is then recovered. By such processing, oil is recovered from the oil sand stratum 2 and hydroxide of the amphoteric metal is recovered from the reaction product produced by the reaction, so that the oil-recovery costs can be reduced further.

A method for recovering oil that is newly extracted from an oil sand stratum 2 or a core stratum 2a has been explained above. However, a large amount of oil exists even in soil, mixed with sand, after the oil is recovered through only a vertical hole. This allows separation of oil from the core stratum 2a, which cannot be realized by a conventional method using steam. Also, the oil can be separated and recovered without using steam, and therefore there is no need for combusting natural gas or the like to produce steam, which serves both to prevent environmental problems and to reduce oil-recovery costs.

### BRIEF DESCRIPTION OF THE DRAWINGS

FIG. 1 is a cross-sectional view that shows the first embodiment of the present invention.

FIG. 2 is a cross-sectional view that shows the second embodiment of the present invention.

FIG. 3 is a flow chart that shows the third embodiment of the present invention.

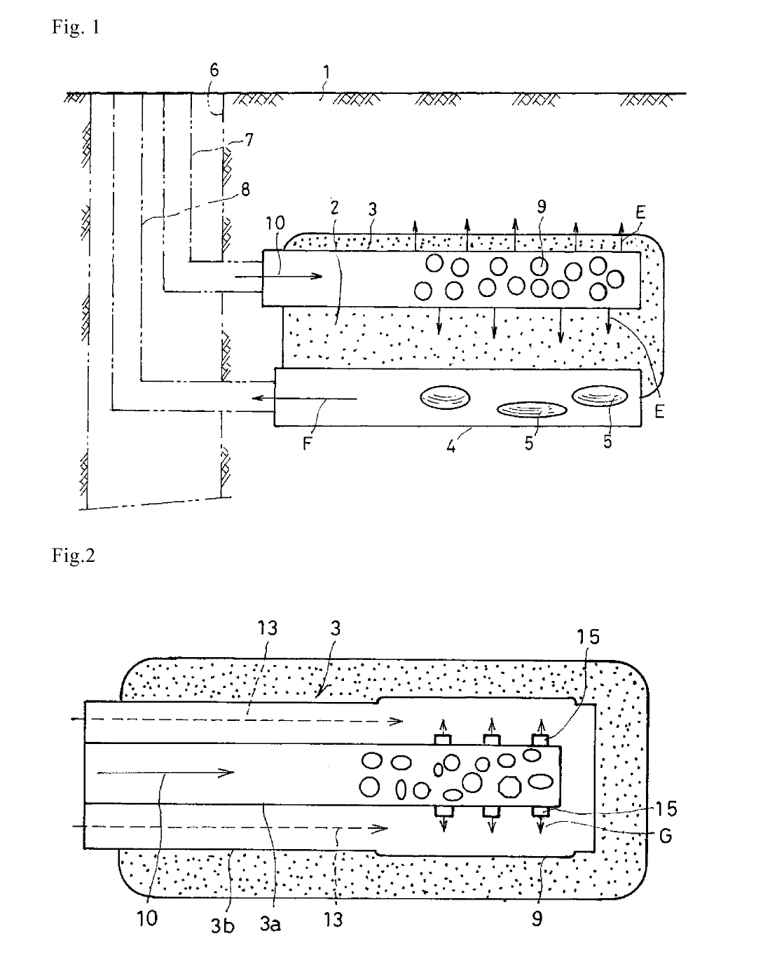

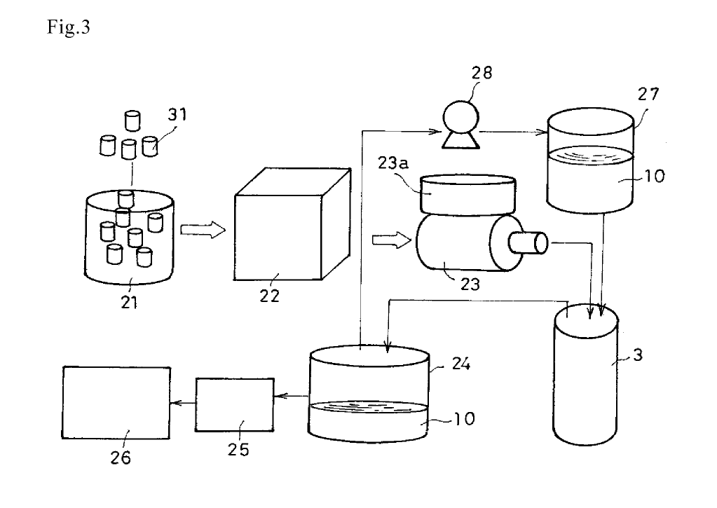

### EXPLANATIONS OF NUMBERS USED IN THE DRAWINGS

1 soil
2 oil sand stratum
3 reaction pipe
3a inner pipe
3b outer pipe
4 recovery pipe
5 oil
6 pit
7,8 connection pipe
9 amphoteric metal or its alloy
10 alkaline aqueous solution
13 arrow showing direction of flow of oxygen gas
15 combustion means
21 preprocessing tank
22 smasher
23 feeder
23a hopper for feeder
24 recovery tank
25 separation tank
26 crystallizing tank
27 alkali tank
28 pump
31 waste materials of amphoteric metal or its alloy

What is claimed is:

1. A method for recovering oil, wherein
after amphoteric metal or its alloy is filled inside at least one of two pipes that are parallelly inserted into an oil sand stratum, an alkaline aqueous solution is supplied to react with the amphoteric metal or its alloy, and
both the heat and the hydrogen that are generated by said reaction are exerted on the oil sand stratum so as to separate oil from the oil sand stratum, which oil is then collected and subsequently recovered via the other pipe.

2. A method for recovering oil, wherein
after amphoteric metal or its alloy is inserted inside at least one of two pipes that are parallelly inserted into an oil sand stratum, an alkaline aqueous solution is supplied to react with the amphoteric metal or its alloy, and
the hydrogen generated by this reaction is combusted, and the heat generated by said combustion is exerted on the oil sand stratum so as to separate the oil from the oil sand stratum, which oil is then collected and subsequently recovered via the other pipe.

3. The method of claim 2 for recovering oil, wherein there is exerted on the oil sand stratum both heat from the combustion of the hydrogen and heat generated by the reaction of the alkaline aqueous solution with the amphoteric metal or its alloy.

4. The method of claim 1, for recovering oil, wherein amphoteric metal used is one or more selected from among aluminum (Al), zinc (Zn), tin (Sn), and lead (Pb).

5. The method of claim 1, for recovering oil, wherein an alkaline aqueous solution used contains one or more selected from among sodium hydroxide (NaOH), potassium hydroxide (KOH), and calcium hydroxide (Ca(OH)₂).

6. The method of claim 1, for recovering oil, wherein hydroxide of the amphoteric metal is separated and recovered from a reaction product generated by the reaction of the amphoteric metal or its alloy and the alkaline aqueous solution.

7. The method of claim 1, for recovering oil, wherein both hydroxide of the amphoteric metal and the alkaline aqueous solution are simultaneously separated from and recovered from said reaction product, so as to enable reuse of the alkaline aqueous solution.

8. A device for recovering oil, with said device consisting of
at least two pipes that are inserted into the soil, one of which pipes is filled with amphoteric metal or its alloy, and
an alkali tank that stores an alkaline aqueous solution, and
with the other pipe supplying the alkaline aqueous solution from said alkali tank to said reaction pipe, applying and exerting on said oil the hydrogen and reaction heat that are generated by a reaction of the alkaline aqueous solution and amphoteric metal or its alloy, and then collecting and recovering the resultant flown oil.

9. A device for recovering oil, with said device consisting of
at least two pipes that are inserted into said soil, one of which pipes is filled with amphoteric metal or its alloy,
an alkali tank that stores an alkaline aqueous solution, and
a combustion means that supplies the alkaline aqueous solution from said alkali tank to said reaction pipe and then combusts hydrogen that is generated by reacting the alkaline aqueous solution with said amphoteric metal or its alloy,
and with the other pipe applying and exerting on said oil the heat that is generated by said combustion of hydrogen, then collecting and recovering the resultant flown oil that is produced due to the heat generated by said combustion of hydrogen.

10. The device of claim 8, for recovering oil, wherein said two pipes are provided in an oil sand stratum or in a core stratum below said oil sand stratum.

11. The device of claim 8, for recovering oil, wherein amphoteric metal used is one or more selected from among aluminum (Al), zinc (Zn), tin (Sn), and lead (Pb).

12. The device of claim 8, for recovering oil, wherein an alkaline aqueous solution used contains one or more selected from among sodium hydroxide (NaOH), potassium hydroxide (KOH), and calcium hydroxide (Ca(OH)₂).

13. The device of claim 8, for recovering oil, wherein said device includes a recovery tank that is provided to recover and precipitate a reaction product generated by the reaction of the alkaline aqueous solution and amphoteric metal or its alloy, and such that said recovery tank is connected with said alkali tank so as to recirculate the unused alkaline aqueous solution, which is a supernatant, from said recovery tank.

14. The method of claim 2, for recovering oil, wherein amphoteric metal used is one or more selected from among aluminum (Al), zinc (Zn), tin (Sn), and lead (Pb).

15. The method of claim 2, for recovering oil, wherein an alkaline aqueous solution used contains one or more selected from among sodium hydroxide (NaOH), potassium hydroxide (KOH), and calcium hydroxide (Ca(OH)₂).

16. The method of claim 2, for recovering oil, wherein hydroxide of the amphoteric metal is separated and recovered from a reaction product generated by the reaction of the amphoteric metal or its alloy and the alkaline aqueous solution.

17. The method of claim 2, for recovering oil, wherein both hydroxide of the amphoteric metal and the alkaline aqueous solution are simultaneously separated from and recovered from said reaction product, so as to enable reuse of the alkaline aqueous solution.

18. The device of claim 9, for recovering oil, wherein said two pipes are provided in an oil sand stratum or in a core stratum below said oil sand stratum.

19. The device of claim 9, for recovering oil, wherein amphoteric metal used is one or more selected from among aluminum (Al), zinc (Zn), tin (Sn), and lead (Pb).

20. The device of claim 9, for recovering oil, wherein an alkaline aqueous solution used contains one or more selected from among sodium hydroxide (NaOH), potassium hydroxide (KOH), and calcium hydroxide (Ca(OH)₂).

21. The device of claim 9, for recovering oil, wherein said device includes a recovery tank that is provided to recover and precipitate a reaction product generated by the reaction of the alkaline aqueous solution and amphoteric metal or its alloy, and such that said recovery tank is connected with said alkali tank so as to recirculate the unused alkaline aqueous solution, which is a supernatant, from said recovery tank.
